(19) United States
(12) Patent Application Publication
(10) Pub. No.: US 2026/0353293 A1
(43) Pub. Date: Nov. 5, 2026

(54) WAKE-UP SIGNAL PROTOCOLS FOR AMBIENT POWER ENABLED WIRELESS DEVICES

(71) Applicant: QUALCOMM Incorporated, San Diego, CA (US)

(72) Inventors: Sanket Sanjay KALAMKAR, San Diego, CA (US); George CHERIAN, San Diego, CA (US); Alfred ASTERJADHI, San Diego, CA (US)

(21) Appl. No.: 19/197,892

(22) Filed: May 2, 2025

(51) Int. Cl. H04W 52/02; H04L 5/00

(52) U.S. Cl. CPC H04W 52/0235; H04L 5/0055

(57) ABSTRACT

This disclosure provides methods, components, devices and systems for wake-up signal (WUS) protocols for ambient power (AMP) enabled wireless devices. Some aspects more specifically relate to signaling and techniques that provide specific protocol, frame exchanges, and frame formats for AMP wireless devices. In some examples, a WUS to may be transmitted by an AMP access point (AP) to wake up an AMP wireless device and enable exchange of one or more data packets between the AMP wireless device and the AMP AP. If the AMP wireless device that receives the AMP wake-up frame is capable of uplink AMP transmission, it may transmit an acknowledgment frame to indicate a readiness for exchanging one or more non-AMP data packets. An AP that successfully receives the acknowledgment frame may exchange non-AMP data packets PPDUs with the AMP wireless device.

### TECHNICAL FIELD

This disclosure relates generally to wireless communication and, more specifically, to wake-up signal protocols for ambient power (AMP) enabled wireless devices.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a station (STA). The method may include receiving, an ambient power (AMP) wake-up signal at the STA in an AMP physical layer protocol data unit (PPDU), transmitting, responsive to the AMP wake-up signal, an acknowledgment message that indicates a readiness at the STA for exchanging one or more non-AMP PPDUs, and exchanging, subsequent to the acknowledgment message, the one or more non-AMP PPDUs.

Another innovative aspect of the subject matter described in this disclosure can be implemented in a STA for wireless communications. The STA may include a processing system that includes processor circuitry and memory circuitry that stores code. The processing system may be configured to cause the STA to receive, an AMP wake-up signal at the STA in an AMP PPDU, transmit, responsive to the AMP wake-up signal, an acknowledgment message that indicates a readiness at the STA for exchanging one or more non-AMP PPDUs, and exchange, subsequent to the acknowledgment message, the one or more non-AMP PPDUs.

Another innovative aspect of the subject matter described in this disclosure can be implemented in a STA for wireless communications. The STA may include means for receiving, an AMP wake-up signal at the STA in an AMP PPDU, means for transmitting, responsive to the AMP wake-up signal, an acknowledgment message that indicates a readiness at the STA for exchanging one or more non-AMP PPDUs, and means for exchanging, subsequent to the acknowledgment message, the one or more non-AMP PPDUs.

Another innovative aspect of the subject matter described in this disclosure can be implemented in a non-transitory computer-readable medium storing code for wireless communications. The code may include instructions executable by one or more processors to receive, an AMP wake-up signal at the STA in an AMP PPDU, transmit, responsive to the AMP wake-up signal, an acknowledgment message that indicates a readiness at the STA for exchanging one or more non-AMP PPDUs, and exchange, subsequent to the acknowledgment message, the one or more non-AMP PPDUs.

In some examples of the method, STAs, and non-transitory computer-readable medium described herein, the acknowledgment message includes an AMP acknowledgment frame transmitted in an AMP PPDU. In some examples of the method, STAs, and non-transitory computer-readable medium described herein, the AMP wake-up signal may be received at an ambient power radio of the STA, and the acknowledgment message may be transmitted from a main radio of the STA. In some examples of the method, STAs, and non-transitory computer-readable medium described herein, the AMP wake-up signal indicates one or more identifiers, of one or more STAs. In some examples of the method, STAs, and non-transitory computer-readable medium described herein, the acknowledgment message may be transmitted responsive to a determination at the STA that a sufficient amount of ambient power has been harvested to exchange non-AMP frames. In some examples of the method, STAs, and non-transitory computer-readable medium described herein, the one or more non-AMP PPDUs may be received at the STA subsequent to a transition delay after transmitting the acknowledgement message.

In some examples of the method, STAs, and non-transitory computer-readable medium described herein, the acknowledgment message includes a PS poll frame that may be transmitted in an uplink non-AMP PPDU. In some examples of the method, STAs, and non-transitory computer-readable medium described herein, the AMP wake-up signal may be provided in an AMP wake-up frame that includes an identifier of an AP that transmitted the AMP wake-up signal, and an identifier of the STA and the identifier of the STA may be provided in a unicast identifier that indicates only the identifier of the STA or a multicast identifier that indicates two or more STAs. In some examples of the method, STAs, and non-transitory computer-readable medium described herein, the acknowledgment message may be provided in an AMP acknowledgment frame that includes the identifier of the STA and the identifier of the AP.

Another innovative aspect of the subject matter described in this disclosure can be implemented in a method for wireless communications by an AP. The method may include transmitting, to an AMP-enabled STA, an AMP wake-up signal in an AMP PPDU, receiving an acknowledgment message that indicates a readiness at the STA for exchanging one or more non-AMP PPDUs, and exchanging, subsequent to the acknowledgment message, the one or more non-AMP PPDUs with the AMP-enabled STA.

Another innovative aspect of the subject matter described in this disclosure can be implemented in an AP for wireless communications. The AP may include a processing system that includes processor circuitry and memory circuitry that stores code. The processing system may be configured to cause the AP to transmit, to an AMP-enabled STA, an AMP wake-up signal in an AMP PPDU, receive an acknowledgment message that indicates a readiness at the STA for exchanging one or more non-AMP PPDUs, and exchange, subsequent to the acknowledgment message, the one or more non-AMP PPDUs with the AMP-enabled STA.

Another innovative aspect of the subject matter described in this disclosure can be implemented in an AP for wireless communications. The AP may include means for transmitting, to an AMP-enabled STA, an AMP wake-up signal in an AMP PPDU, means for receiving an acknowledgment message that indicates a readiness at the STA for exchanging one or more non-AMP PPDUs, and means for exchanging, subsequent to the acknowledgment message, the one or more non-AMP PPDUs with the AMP-enabled STA.

Another innovative aspect of the subject matter described in this disclosure can be implemented in a non-transitory computer-readable medium storing code for wireless communications. The code may include instructions executable by one or more processors to transmit, to an AMP-enabled STA, an AMP wake-up signal in an AMP PPDU, receive an acknowledgment message that indicates a readiness at the STA for exchanging one or more non-AMP PPDUs, and exchange, subsequent to the acknowledgment message, the one or more non-AMP PPDUs with the AMP-enabled STA.

In some examples of the method, APs, and non-transitory computer-readable medium described herein, the acknowledgment message includes an AMP acknowledgment frame transmitted in an AMP PPDU. In some examples of the method, APs, and non-transitory computer-readable medium described herein, the AMP wake-up signal indicates one or more identifiers, of one or more STAs. In some examples of the method, APs, and non-transitory computer-readable medium described herein, the one or more non-AMP PPDUs may be transmitted to the STA subsequent to a transition delay after receiving the acknowledgement message.

In some examples of the method, APs, and non-transitory computer-readable medium described herein, the acknowledgment message includes a PS poll frame. In some examples of the method, APs, and non-transitory computer-readable medium described herein, the AMP wake-up signal may be provided in an AMP wake-up frame that includes an identifier of the AP, and an identifier of the AMP-enabled STA and the identifier of the AMP-enabled STA may be provided in a unicast identifier that indicates only the identifier of the AMP-enabled STA or a multicast identifier that indicates two or more STAs. In some examples of the method, APs, and non-transitory computer-readable medium described herein, the acknowledgment message may be provided in an AMP acknowledgment frame that includes the identifier of the AMP-enabled STA and the identifier of the AP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless access point (AP) and one or more wireless stations (STAs).

FIGS. 3A and 3B show examples of signaling diagrams that support wake-up signal (WUS) protocols for ambient power (AMP) enabled wireless devices.

FIGS. 4 through 7 show examples of process flows that support WUS protocols for AMP enabled wireless devices.

FIG. 8 shows an example of an AMP frame format that supports WUS protocols for AMP enabled wireless devices.

FIG. 9 shows an example of an AMP-enabled non-AP STA state diagram that supports WUS protocols for AMP enabled wireless devices.

FIG. 10 shows a block diagram of an example wireless communication device that supports WUS protocols for AMP enabled wireless devices.

FIG. 11 shows a block diagram of an example wireless communication device that supports WUS protocols for AMP enabled wireless devices.

FIG. 12 shows a flowchart illustrating an example process performable by or at a STA that supports WUS protocols for AMP enabled wireless devices.

FIG. 13 shows a flowchart illustrating an example process performable by or at an AP that supports WUS protocols for AMP enabled wireless devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support various deployments for ambient power (AMP)-enabled communications (such as AMP deployments). In such deployments, one or more wireless communication devices may lack an internal power source (such as a battery) or may otherwise have relatively limited energy storage or other capabilities. Such devices may perform energy harvesting using one or more energy sources or signals to communicate (such as transmit or receive) data. In some examples, these devices may be relatively low-complexity devices (such as due to an environment in which the device operates, due to a functionality of the device, due to a form factor of the device, due to a relatively reduced cost of the device, or due to a design of the device, among other examples) and may be referred to as AMP wireless devices, energy-harvesting devices, ambient power tags, low-power devices, zero-power devices, ambient power-enabled Internet of Things (IoT) devices, or similar nomenclature.

Deployments including one or more AMP wireless devices may be associated with various configurations for supporting energy harvesting and AMP-enabled communications. For example, one or more devices (such as one or more access points (APs), stations (STAs), relays, readers, or the like) may provide a signal (such as an energizing signal, an energizer signal, or an excitation signal) to an AMP wireless device such that the AMP wireless device harvests the energy from the signal and supplies power to (for example, powers up, or activates) one or more components (such as one or more radio frequency (RF) components, or one or more processing components) of the AMP wireless device for communications. After the components are powered up, data may be communicated between the AMP wireless device and the one or more devices that provided the signal. Additionally, or alternatively, the AMP wireless device may communicate with one or more other devices (such as one or more APs, STAs, relays, readers, or the like) that did not provide the energizing signal. In some examples, one or more additional devices (such as energizers, or energizing devices), which may not communicate control information or data with the AMP wireless device, may supply the energizing signals that are used for energy harvesting at the AMP wireless devices.

In some deployments, an AMP wireless device may be an AMP-enabled non-AP STA, such as a non-AP STA that is also capable of exchanging AMP downlink physical layer protocol data units (PPDUs). Such an AMP-enabled non-AP STA may support AMP wake-up and control signaling using an AMP radio to reduce power consumption, support existing 802.11 standards using a main radio (such as a Wi-Fi radio), and provide for RF energy harvesting (S1G or 2.4 GHz). In some deployments, an AMP AP may have an ability to transmit AMP wake-up and control signals to an AMP-enabled non-AP STA, or may relay data between the AMP client and a legacy 802.11 AP (such as an AMP AP that may be collocated with a legacy 802.11 AP), and in some cases may also itself act as an AMP enabled non-AP STA in certain scenarios (such as an AMP mobile AP associated with a legacy 802.11 AP). An AMP-enabled non-AP STA in such deployments may be capable of receiving an AMP wake-up or control signal in an AMP frame using a low-power AMP radio, which prompts the device to wake up to exchange data in one or more 802.11 frames using a higher-power main radio (such as after receiving an AMP wake-up signal, or after contending for the medium). An AMP-enabled non-AP STA may also include at least some persistent memory, and may thus retain information across multiple sessions even when the power is lost (such as power loss caused by insufficient harvested energy). Additionally, clock drift in an AMP-enabled non-AP STA may also be present, which may include a similar amount of clock drift as legacy 802.11 devices for the main radio, but the AMP radio may have a relatively large amount of drift (such as 1000-10000 ppm)

In example scenarios where AMP wireless devices are deployed, signaling techniques that support efficient and low-power communications across deployment configurations may be desirable. Further, the relatively low complexity of some AMP wireless devices may support a relatively small number of transmissions and receptions within one communications session, and techniques that provide wake-up and PPDU communications may be desirable.

Various aspects relate generally to ambient power-enabled communications and ambient power deployments. Some aspects more specifically relate to signaling and techniques that provide specific protocol, frame exchanges, and frame formats for AMP wireless devices, such as AMP-enabled non-AP STAs. In some examples, an AMP PPDU may be transmitted in a wake-up signal by an AMP AP to wake up an AMP wireless device and enable exchange of one or more non-AMP PPDUs between the AMP wireless device and the AMP AP (or a different AP). An AMP PPDU may refer to a PPDU associated with an AMP transmission, and a non-AMP PPDU may refer to a PPDU transmitted using a main radio (which may be referred to interchangeably as a Wi-Fi radio or higher-power radio) such as a Wi-Fi PPDU. In some examples, to facilitate wake-up signaling, the AMP AP may transmit an AMP wake-up frame, such as over an AMP radio (which may be referred to interchangeably as a low-power radio), to wake up an AMP-enabled STA (which may activate a main radio). In some examples, the AMP wake-up frame may be transmitted in an AMP PPDU, where a unicast AMP wake-up frame may include an identifier of a specific AMP wireless device and a multicast wake-up frame may include a list of identifiers for AMP wireless devices that are to wake up.

In some examples, if the AMP wireless device that receives the AMP wake-up frame is capable of uplink AMP transmission, it may transmit an acknowledgment frame to indicate a readiness for exchanging one or more non-AMP PPDUs. In some examples, the acknowledgment frame may be an AMP acknowledgment frame (such as transmitted via the AMP radio), and in other examples the acknowledgment frame may be a power-save (PS) poll frame that is transmitted in an uplink PPDU (such as via the main radio). An AP that successfully receives the acknowledgment frame may exchange non-AMP PPDUs with the AMP wireless device (such as using the main radio in accordance with an 802.11 protocol). In some examples, exchange of non-AMP PPDUs may begin after a transition delay that may correspond to a time for the AMP wireless device to wake up and activate one or more RF components. In some examples, the AMP wireless device may support multi-link operation (MLO), and the AMP acknowledgment frame or the AMP wake-up signal may indicate one or more links of the multiple available links that are to be activated at the AMP wireless device. In some examples, an AMP wireless device may transition between two or more power states in accordance with a duty cycle, and information related to the duty cycle may be provided to the AMP AP, which may transmit wake up signals in accordance with the indicated duty cycle.

Particular aspects of the subject matter described in this disclosure can be implemented to realize one or more of the following potential advantages. In some examples, by providing an AMP wake-up signal and an associated acknowledgment message, the described techniques can be used to efficiently wake up an AMP wireless device and exchange non-AMP PPDUs. Such techniques may allow a main radio at an AMP wireless device to remain in a sleep or inactive mode when not exchanging non-AMP PPDUs, and reduce power consumption. Further, by providing an identifier of an AMP wireless device in an AMP wake-up signal for unicast or multicast wake-up signals, AMP wireless devices may be unambiguously identified and transmit a corresponding acknowledgement to the AMP AP. In some examples, by providing a transition delay prior to exchanging non-AMP PPCUs, sufficient time for an AMP wireless device to power up related RF components may be provided. Further, by providing an indication of a particular link to be used in a MLO indication, power at the AMP wireless device may be conserved while unambiguously communicating on one or more particular links. In still further examples, by providing an indication of a power state duty cycle, power savings at an AMP wireless device may be achieved while providing an efficient schedule for transmitting wake-up signals.

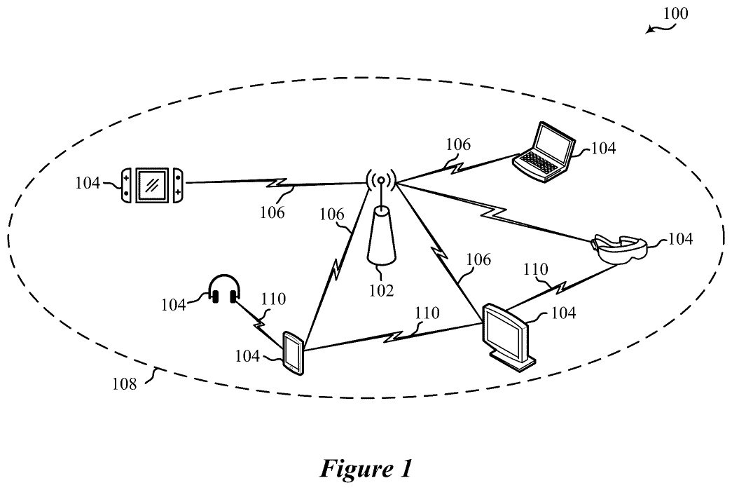

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

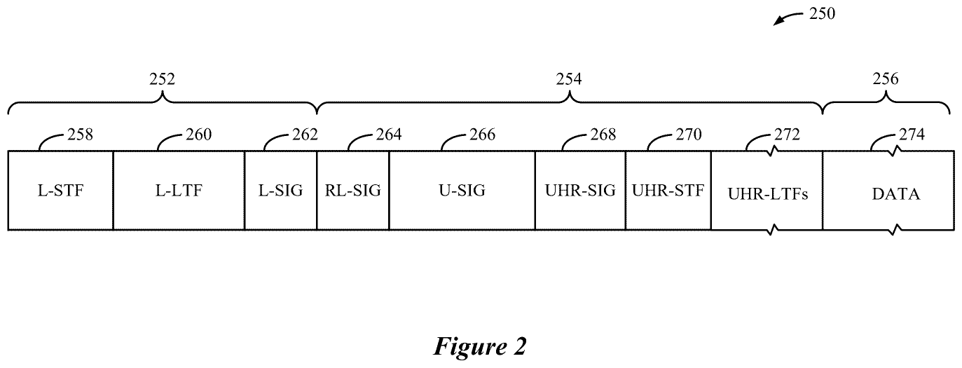

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (for example, STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (for example, a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (for example, a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

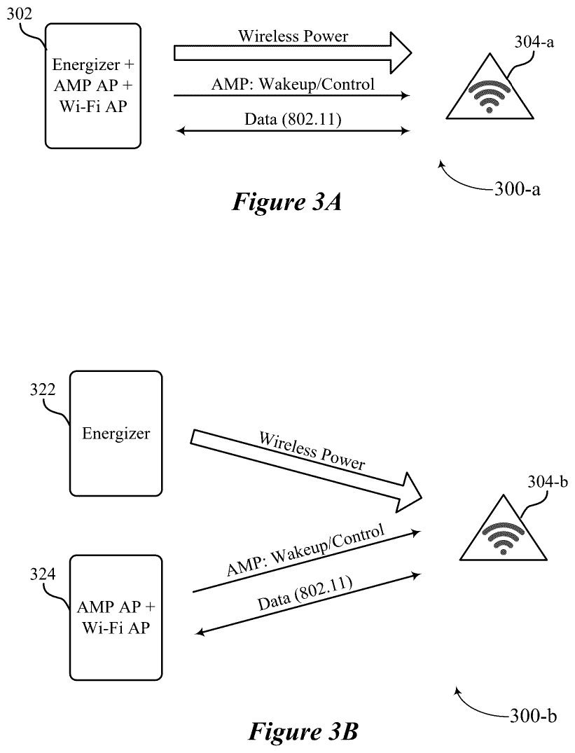

FIGS. 3A and 3B show examples of signaling diagrams 300 (for example, 300-a and 300-b) that support WUS protocols for AMP-enabled wireless devices. In some aspects, the signaling diagrams 300 may be examples of networks that support ambient power-enabled wireless communications. As such, each signaling diagram 300 may be an example of a respective deployment or configuration of one or more devices that enable the ambient power-enabled wireless communications. For example, each signaling diagram 300 may include at least one AMP wireless device 304 (for example, an AMP-enabled non-AP STA, an energy-harvesting device, an AMP tag, a low-power device, an AMP IoT device, or an AMP device) and one or more other devices that provide an energizing signal (for example, an energizer signal) to the AMP wireless device 304 or communicate data with the AMP wireless device 304.

In some cases, the AMP wireless device 304 may include RF components associated with the ambient power-enabled communications, as well as RF components that support wireless communications in accordance with the IEEE 802.11 family of wireless communication protocol standards (for example, a main radio, an 802.11-capable radio, or the like). In such examples, the AMP wireless device 304 may support the ambient power-enabled communications and various types of data transmission (such as TCP data, IP data, QoS data, among other examples) using one or more sets of RF components.

As illustrated in the pictorial diagram of FIG. 3A, the example signaling diagram 300-a may include a wireless communication device 302 and an AMP wireless device 304-a. The wireless communication device 302 may provide power to the AMP wireless device 304-a and communicate control signals or data with the AMP wireless device 304-a. For example, the wireless communication device 302 may transmit one or more signals (for example, energizing signals) that are used by the AMP wireless device 304-a to harvest energy from the signal(s) and supply power to one or more RF components of the AMP wireless device 304-a for communications with the wireless communication device 302. Further, after the AMP wireless device 304-a supplies power to one or more RF components (for example, powers up at least one AMP radio) using the harvested energy, the wireless communication device 302 may transmit one or more wakeup signals or control signals for enabling communications between the AMP wireless device 304-a and the wireless communication device 302. The wakeup signals or control signals may be received or processed by the AMP wireless device 304-a via RF components associated with the ambient power-enabled communications (for example, an AMP radio, or an AMP transceiver). In some examples, the AMP wireless device 304-a may receive a wake-up signal, and transmit an acknowledgment message that indicates the readiness of the AMP wireless device 304-a communicate data (such as one or more non-AMP PPDUs in accordance with 802.11 protocols) with the wireless communication device 302, such as via a Wi-Fi radio or main radio. In some examples, if there is no data to be communicated, the one or more energizing signals may be stopped (for example, paused, halted, or interrupted), and the AMP wireless device 304-a may subsequently power down (for example, due to an absence of power available for harvesting, until the one or more energizing signals are transmitted/received again). In some examples, one or more servers may be connected to or otherwise in communication with the wireless communication device 302. In such examples, the one or more servers may communicate with the wireless communication device 302, such as one or more query messages or one or more response messages associated with communicating with the AMP wireless device 304-a.

In some examples, the wireless communication device 302 may be referred to as a reader, AMP reader, or reader device, and the wireless communication device 302 may be an example of an AP (such as an AP 102), a network entity, a STA (such as a STA 104), a handheld device, a smart phone, a specialized AMP reader, or another device. Additionally, or alternatively, the wireless communication device 302 may be referred to as an AMP AP or energizer, which may support both the transmission of energizing signals to the AMP wireless device 304-a and data exchange with the AMP wireless device 304-a.

In FIG. 3B, the pictorial diagram of the signaling diagram 300-b includes respective devices that may provide an energizing signal and communicate data with an AMP wireless device 304-b. For example, the signaling diagram 300-b may include a first wireless communication device 322 and a second wireless communication device 324. The first wireless communication device 322 may provide one or more signals (such as energizing signals) to the AMP wireless device 304-b, which may enable the AMP wireless device 304-b to harvest energy and communicate with one or more other devices. For instance, one or more signals (such as wakeup signals, control signals, or any combination thereof) and data may be communicated (for example, directly communicated) between the second wireless communication device 324 and the AMP wireless device 304-b. In the example of the signaling diagram 300-b, the data may be associated with the IEEE 802.11 wireless communication protocol standards (such as 802.11 data PPDUs).

As an example, the first wireless communication device 322 may transmit one or more signals (such as energizing signals) that are used by the AMP wireless device 304-b for energy harvesting to supply power to one or more RF components of the AMP wireless device 304-b for communications with the second wireless communication device 324. After the AMP wireless device 304-b supplies power to the one or more RF components (for example, powers up at least one radio, such as an AMP radio, a main radio, a Wi-Fi radio, or the like) using the harvested energy from the first wireless communication device 322, the second wireless communication device 324 may transmit one or more wakeup signals, control signals, or both, for enabling communications between the AMP wireless device 304-b and the second wireless communication device 324. In some examples, the wakeup signals, control signals, or both, may be received or processed by the AMP wireless device 304-b using RF components associated with the ambient power-enabled communications (such as the AMP radio, or an AMP transceiver). In some examples, the AMP wireless device 304-b may include both the AMP radio/RF components and one or more RF components associated with communicating 802.11 data (such as a main radio, an 802.11-capable radio, or the like). In such examples, the AMP wireless device 304-b may communicate 802.11 data with the second wireless communication device 324 via the main radio, whereas the energizing signals, wakeup signals, or control signals may be communicated via the AMP radio. The 802.11 data may be exchanged between the second wireless communication device 324 and the AMP wireless device 304-b without being relayed via the first wireless communication device 322.

The first wireless communication device 322 may be an example of an AP (such as an AP 102), a network entity, a STA (such as a STA 104), a handheld device, a smart phone, a specialized AMP device, or another device. The first wireless communication device 322 may be referred to as an energizer, energizing device, or similar terminology. The second wireless communication device 324 may be an example of an AP (such as an AP 102), a network entity, a STA (such as a STA 104), a handheld device, a smart phone, or another device. Additionally, or alternatively, the second wireless communication device 324 may be referred to as an 802.11 AP, a relay AP (for example, the second wireless communication device 324 may relay data to/from the AMP wireless device 304-b and one or more other devices), or some similar terminology, and the second wireless communication device 324 may support the exchange of data with the AMP wireless device 304-b.

In some aspects, an AMP wireless device 304 of FIG. 3A or FIG. 3B may be authenticated with an AP (such as an AMP AP or Wi-Fi AP) in accordance with a Wi-Fi authentication protocol, in which an additional temporal key (TK) may be generated for protected individually and group addressed AMP frames. In some aspects, an authentication key may be maintained across sessions due to persistent memory at the AMP wireless device 304. Further, the AMP wireless device 304 may be associated with an AP based on an associated identifier (AID) or temporary ID to the AMP wireless device 304 assigned during a Wi-Fi association procedure. In some aspects, the AID for Wi-Fi frame exchanges may be separate from the AID used by the AMP wireless device 304 for AMP frames. Further, the AMP wireless device 304 may include some amount of persistent memory, and may retain the AID or the temporary ID across sessions. In some aspects, association signaling can be extended to include AMP mode setup, where AMP capabilities may be exchanged during an AMP mode setup, and/or AMP mode setup or updates can also be performed post-association.

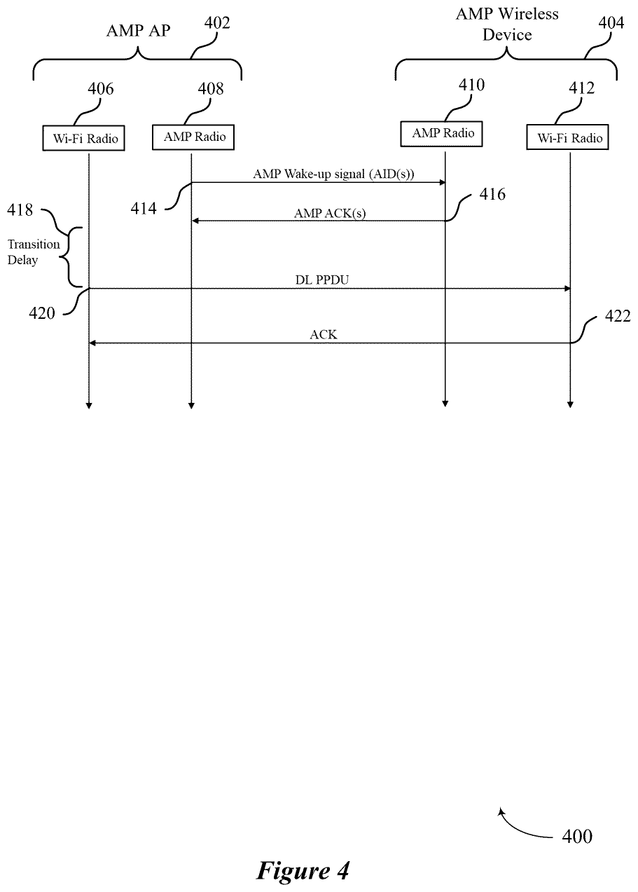

FIG. 4 shows an example of a process flow 400 that supports WUS protocols for AMP enabled wireless devices. The process flow 400 may implement aspects of, or be implemented by aspects of, the wireless communication network 100, the PPDU 250, or the signaling diagrams 300. For example, the process flow 400 may include an AMP AP 402 and an AMP wireless device 404. The AMP AP 402 may be an example of an AP (such as an AP 102, an intermediate device 112, or a Wi-Fi plus AMP AP), a network entity, a STA (such as a STA 104), a handheld device, a smart phone, a specialized AMP reader, or another device. In some examples, the AMP wireless device 404 may be an example of a STA (such as STA 104), an AMP-enabled non-AP STA, a handheld device, a smart phone, an AMP device, an AMP tag, or another device. Techniques such as illustrated in FIG. 4 may provide for efficient and reliable communications between the AMP AP 402 and the AMP wireless device 404.

In the following description of process flow 400, the operations may be performed in a different order than the order shown, or other operations may be added or removed from the process flow 400. For example, some operations also may be left out of process flow 400, may be performed in different orders or at different times, or other operations may be added to process flow 400. Although communications of the process flow 400 are shown occurring between an AMP AP 402, and an AMP wireless device 404, the operations of process flow 400 also may be performed by one or more other wireless devices, network devices, or network functions.

In this example, the AMP AP 402 may include a Wi-Fi radio 406 and an AMP radio 408. Further, the AMP wireless device 404 may include a Wi-Fi radio 412 and an AMP radio 410. While separate radios are illustrated in this example, in other examples a same radio may be used for Wi-Fi and AMP communications at one or both of the AMP AP 402 and AMP wireless device 404, or one or more additional radios maybe used (such as a supplemental radio). In this example, at 414, the AMP AP 402 may transmit an AMP WUS (such as from AMP radio 408), which may be received at the AMP wireless device 404 (such as at AMP radio 410). The AMP WUS may include one or more AIDs that indicate that the AMP WUS is intended for the AMP wireless device 404.

With reference to the process flows of FIGS. 4 through 7, while not illustrated, it is noted that the AMP APs, or another AMP device, may transmit an energizing signal to the AMP wireless devices that is used to provide power to the AMP radio and Wi-Fi radio of the AMP wireless devices, and one or more other components (such as processing, decoding, encoding, and other RF components). In some examples, the energizing signal may be transmitted to multiple different AMP wireless devices that are within a proximity of the wireless device. As discussed herein, the energizing signal may provide an energy source for the AMP wireless device to supply power to components of the AMP wireless device. In some examples, the energizing signal may be transmitted in a continuous manner that persist for all, or substantially all, of a communications session with the AMP wireless device (such as a continuous carrier signal in backscatter communications, or a continuous energizing signal that spans multiple frame exchanges between an AMP AP and one or more AMP wireless devices).

With reference again to FIG. 4, at 416, the AMP wireless device 404 may transmit, and the AMP AP 402 may receive, one or more AMP acknowledgment signals. In some aspects, an AMP acknowledgment signal may include an AMP frame or AMP PPDU that indicates the AMP wireless device will be ready to exchange one or more non-AMP PPDUs. In this example, the AMP acknowledgment signal may be transmitted using AMP radio 410 of the AMP wireless device 404 and may be received using AMP radio 408 of the AMP AP 402. In some aspects, the AMP AP 402 may wait for a transition delay 418 before transmitting using the Wi-Fi radio 406, which may allow the AMP wireless device 404 time to activate one or more components, such as Wi-Fi radio 412, for example. At 420, the AMP AP 402 may transmit, and the AMP wireless device 404 may receive, a downlink PPDU. For example, a non-AMP PPDU, such as a Wi-Fi PPDU, may be transmitted to the AMP wireless device 404. At 422, the AMP wireless device 404 may transmit, and the AMP AP 402 may receive, an acknowledgement of the transmitted PPDU.

In some examples, the AMP WUS may be transmitted when the AMP AP 402 has downlink data for the AMP wireless device 404, and/or to fetch scheduled uplink data (for example, is an uplink transmission schedule is negotiated). In some aspects, the AMP WUS may include an AMP wake-up frame in an AMP PPDU. In cases where the AMP WUS is a unicast WUS, the AMP wake-up frame may include the AID of the specific AMP wireless device 404 to be awakened. In cases where the AMP WUS is a multicast WUS, the AMP wake-up frame may include a list of AIDs for multiple AMP wireless devices 404 STAs to wake up. In some aspects, if the AMP wireless device 404 is capable of an uplink AMP transmission, it may transmit the AMP acknowledgment as an AMP frame in an uplink AMP PPDU. In some aspects, for multicast wake-up, the AMP acknowledgment frames from multiple AMP wireless devices 404 can be sent as instructed by the AMP AP 402, such as according to a slotted ALOHA procedure or in a deterministic manner. In some aspects, if the AMP AP 402 successfully receives the AMP acknowledgment frame, after the transition delay 418, the AMP AP 402 and the AMP wireless device 404 may exchange non-AMP frames over the Wi-Fi radio in accordance with 802.11 communications.

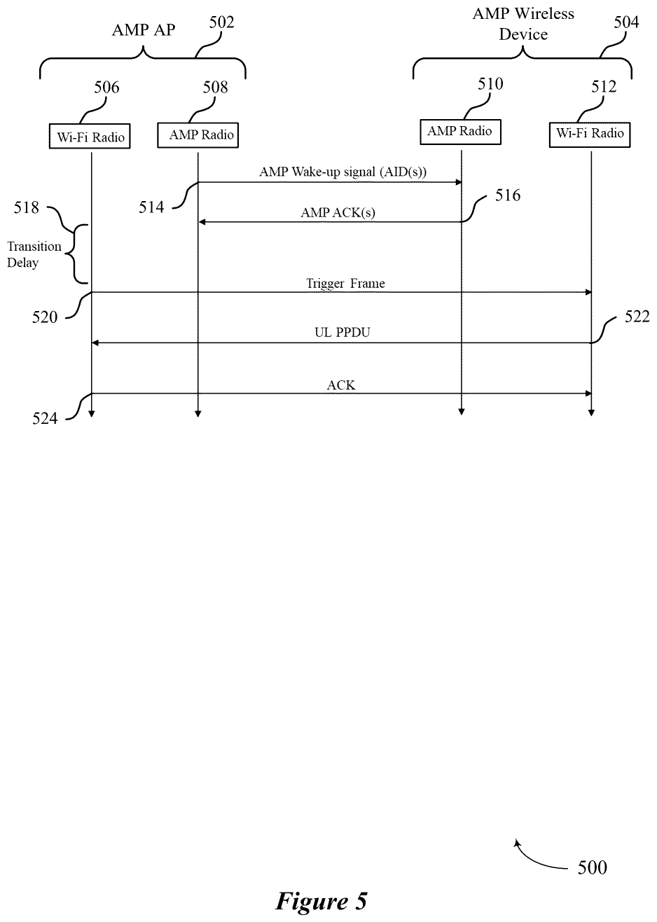

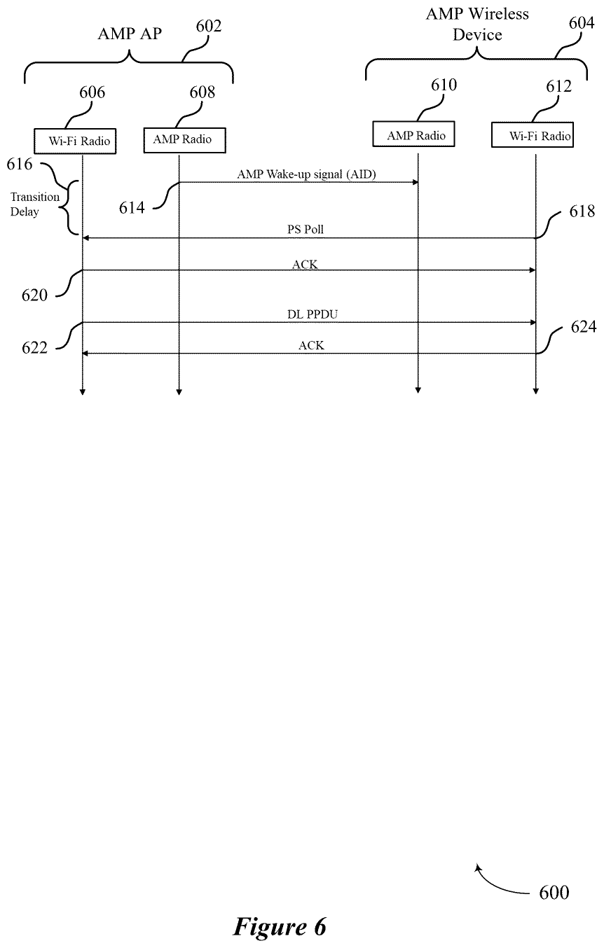

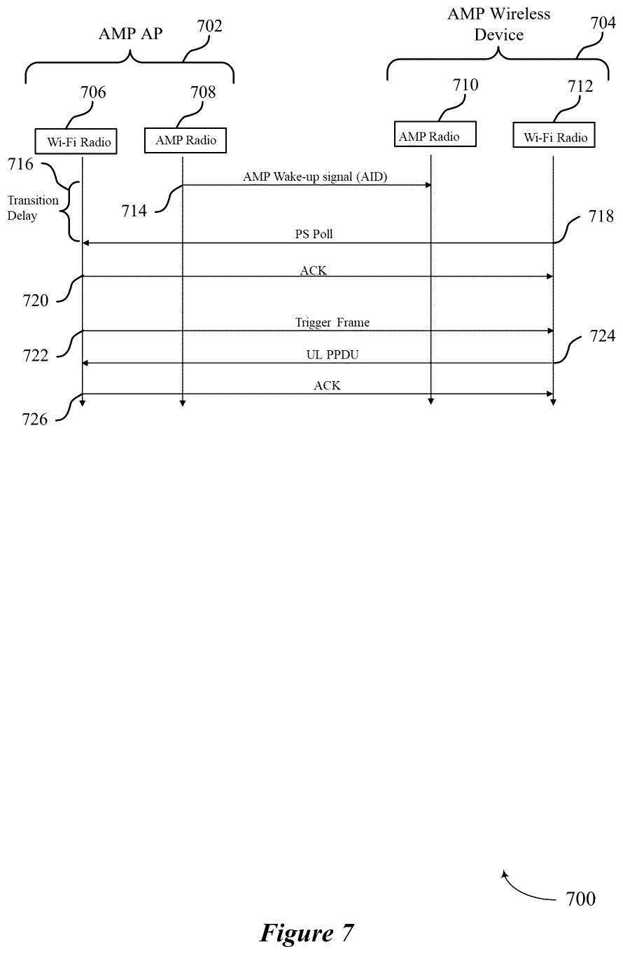

In some aspects, the AMP wireless device 404 may be an MLO STA with multiple links. In such cases, the AMP acknowledgment frame, as a response to the received AMP wake-up frame, may indicate one or more links (such as 2.4 GHz, 5 GHz, or 6 GHz links) the AMP wireless device 404 is going to use for subsequent communications. In other aspects, the AMP AP 402 may indicate, via the AMP wake-up frame, which link the AMP wireless device 404 should use (such as a per link indication, or a multi-link indication). Additionally, the AMP AP 402 may indicate to the AMP wireless device 404 what mode to use upon wake-up, such as a PS mode or active mode, and other TX/RXVECTOR parameters, for example. Further, for unsolicited uplink transmissions, the AMP wireless device 404 may wake up its Wi-Fi radio 412 after harvesting enough energy and use legacy 802.11 techniques to exchange frames with the AMP AP 402. In the event the AMP AP 402 is sleeping the AMP wireless device 404 may attempt to wake the AMP AP 402 using an AMP wake-up frame over the AMP radio. In some aspects, the AMP AP 402 may transmit the AMP wake-up frame when it has downlink data for the AMP wireless device 404, or as per a schedule negotiated with the AMP wireless device 404, and if no AMP acknowledgment frame (or PS-Poll frame, as discussed with reference to FIGS. 6 and 7) is received, the AMP AP 402 may retransmit the AMP wake-up frame. In some aspects, a scheduled uplink transmission may be used to transmit data from the AMP wireless device 404, and an exemplary process flow for such transmissions is discussed with reference to FIG. 5.

FIG. 5 shows an example of a process flow 500 that supports WUS protocols for AMP enabled wireless devices. The process flow 500 may implement aspects of, or be implemented by aspects of, the wireless communication network 100, the PPDU 250, or the signaling diagrams 300. For example, the process flow 500 may include an AMP AP 502 and an AMP wireless device 504. The AMP AP 502 may be an example of an AP (such as an AP 102, an intermediate device 112, or a Wi-Fi plus AMP AP), a network entity, a STA (such as a STA 104), a handheld device, a smart phone, a specialized AMP reader, or another device. In some examples, the AMP wireless device 504 may be an example of a STA (such as STA 104), an AMP-enabled non-AP STA, a handheld device, a smart phone, an AMP device, an AMP tag, or another device. Techniques such as illustrated in FIG. 5 may provide for efficient and reliable communications between the AMP AP 502 and the AMP wireless device 504.

In the following description of process flow 500, the operations may be performed in a different order than the order shown, or other operations may be added or removed from the process flow 500. For example, some operations also may be left out of process flow 500, may be performed in different orders or at different times, or other operations may be added to process flow 500. Although communications of the process flow 500 are shown occurring between an AMP AP 502, and an AMP wireless device 504, the operations of process flow 500 also may be performed by one or more other wireless devices, network devices, or network functions.

In this example, the AMP AP 502 may include a Wi-Fi radio 506 and an AMP radio 508. Further, the AMP wireless device 504 may include a Wi-Fi radio 512 and an AMP radio 510. As discussed with reference to FIG. 4, in other examples a same radio may be used for Wi-Fi and AMP communications at one or both of the AMP AP 502 and AMP wireless device 504, or one or more additional radios maybe used (such as a supplemental radio). In this example, at 514, the AMP AP 502 may transmit an AMP WUS (such as from AMP radio 508), which may be received at the AMP wireless device 504 (such as at AMP radio 510). The AMP WUS may include one or more AIDs that indicate that the AMP WUS is intended for the AMP wireless device 504.

At 516, the AMP wireless device 504 may transmit, and the AMP AP 502 may receive, one or more AMP acknowledgment signals. In some aspects, an AMP acknowledgment signal may include an AMP frame or AMP PPDU that indicates the AMP wireless device will be ready to exchange one or more non-AMP PPDUs. In this example, the AMP acknowledgment signal may be transmitted using AMP radio 510 of the AMP wireless device 504 and may be received using AMP radio 508 of the AMP AP 502.

In some aspects, the AMP AP 502 may wait for a transition delay 518 before transmitting using the Wi-Fi radio 506, which may allow the AMP wireless device 504 time to activate one or more components, such as Wi-Fi radio 512, for example. At 520, the AMP AP 502 may transmit, and the AMP wireless device 504 may receive, a trigger frame that indicates the AMP wireless device 504 is to transmit one or more uplink PPDUs. At 522, the AMP wireless device 504 may transmit, and the AMP AP 502 may receive, an uplink PPDU. For example, a non-AMP PPDU, such as a Wi-Fi PPDU, may be transmitted to the AMP AP 502. At 524, the AMP AP 502 may transmit, and the AMP wireless device 504 may receive, an acknowledgement of the transmitted PPDU.

As discussed with reference to FIG. 3, in some aspects an acknowledgement of the AMP WUS may be transmitted using a Wi-Fi PPDU, such as a PS-poll transmission. FIGS. 6 and 7 illustrate process flows for some example PS poll based acknowledgment techniques.

FIG. 6 shows an example of a process flow 600 that supports wake-up signal protocols for ambient power enabled wireless devices. The process flow 600 may implement aspects of, or be implemented by aspects of, the wireless communication network 100, the PPDU 250, or the signaling diagrams 300. For example, the process flow 600 may include an AMP AP 602 and an AMP wireless device 604. The AMP AP 602 may be an example of an AP (such as an AP 102, an intermediate device 112, or a Wi-Fi plus AMP AP), a network entity, a STA (such as a STA 104), a handheld device, a smart phone, a specialized AMP reader, or another device. In some examples, the AMP wireless device 604 may be an example of a STA (such as STA 104), an AMP-enabled non-AP STA, a handheld device, a smart phone, an AMP device, an AMP tag, or another device. Techniques such as illustrated in FIG. 6 may provide for efficient and reliable communications between the AMP AP 602 and the AMP wireless device 604.

In the following description of process flow 600, the operations may be performed in a different order than the order shown, or other operations may be added or removed from the process flow 600. For example, some operations also may be left out of process flow 600, may be performed in different orders or at different times, or other operations may be added to process flow 600. Although communications of the process flow 600 are shown occurring between an AMP AP 602, and an AMP wireless device 604, the operations of process flow 600 also may be performed by one or more other wireless devices, network devices, or network functions.

In this example, the AMP AP 602 may include a Wi-Fi radio 606 and an AMP radio 608. Further, the AMP wireless device 604 may include a Wi-Fi radio 612 and an AMP radio 610. As discussed with reference to FIG. 4, in other examples a same radio may be used for Wi-Fi and AMP communications at one or both of the AMP AP 602 and AMP wireless device 604, or one or more additional radios maybe used (such as a supplemental radio). In this example, at 614, the AMP AP 602 may transmit an AMP WUS (such as from AMP radio 608), which may be received at the AMP wireless device 604 (such as at AMP radio 610). The AMP WUS may include one or more AIDs that indicate that the AMP WUS is intended for the AMP wireless device 604.

In this example, the AMP wireless device 604 may be unable to transmit using the AMP radio 610, and upon receipt of the AMP WUS, may wake up the Wi-Fi radio 612 and, at 618, after transition delay 616, may transmit a PS poll PPDU to the AMP AP 602. At 620, the AMP AP 602 may transmit, and the AMP wireless device 604 may receive, an acknowledgment of the PS poll. In this example, the acknowledgment of the PS poll may be transmitted using Wi-Fi radio 606 of the AMP AP 602, and may be received using Wi-Fi radio 612 of the AMP wireless device 604.

At 622, the AMP AP 602 may transmit, and the AMP wireless device 604 may receive, one or more downlink PPDUs (for example, non-AMP PPDUs, such as Wi-Fi PPDUs). At 624, the AMP wireless device 604 may transmit, and the AMP Ap 602 may receive, an acknowledgement of the transmitted downlink PPDU.

FIG. 7 shows an example of a process flow 700 that supports wake-up signal protocols for ambient power enabled wireless devices. The process flow 700 may implement aspects of, or be implemented by aspects of, the wireless communication network 100, the PPDU 250, or the signaling diagrams 300. For example, the process flow 700 may include an AMP AP 702 and an AMP wireless device 704. The AMP AP 702 may be an example of an AP (such as an AP 102, an intermediate device 112, or a Wi-Fi plus AMP AP), a network entity, a STA (such as a STA 104), a handheld device, a smart phone, a specialized AMP reader, or another device. In some examples, the AMP wireless device 704 may be an example of a STA (such as STA 104), an AMP-enabled non-AP STA, a handheld device, a smart phone, an AMP device, an AMP tag, or another device. Techniques such as illustrated in FIG. 7 may provide for efficient and reliable communications between the AMP AP 702 and the AMP wireless device 704.

In the following description of process flow 700, the operations may be performed in a different order than the order shown, or other operations may be added or removed from the process flow 700. For example, some operations also may be left out of process flow 700, may be performed in different orders or at different times, or other operations may be added to process flow 700. Although communications of the process flow 700 are shown occurring between an AMP AP 702, and an AMP wireless device 704, the operations of process flow 700 also may be performed by one or more other wireless devices, network devices, or network functions.

In this example, the AMP AP 702 may include a Wi-Fi radio 706 and an AMP radio 708. Further, the AMP wireless device 704 may include a Wi-Fi radio 712 and an AMP radio 710. As discussed with reference to FIG. 4, in other examples a same radio may be used for Wi-Fi and AMP communications at one or both of the AMP AP 702 and AMP wireless device 704, or one or more additional radios maybe used (such as a supplemental radio). In this example, at 714, the AMP AP 702 may transmit an AMP WUS (such as from AMP radio 708), which may be received at the AMP wireless device 704 (such as at AMP radio 710). The AMP WUS may include one or more AIDs that indicate that the AMP WUS is intended for the AMP wireless device 704.

In this example, the AMP wireless device 704 may be unable to transmit using the AMP radio 710, and upon receipt of the AMP WUS, may wake up the Wi-Fi radio 712 and, at 718, after transition delay 716, may transmit a PS poll PPDU to the AMP AP 702. At 720, the AMP AP 702 may transmit, and the AMP wireless device 704 may receive, an acknowledgment of the PS poll. In this example, the acknowledgment of the PS poll may be transmitted using Wi-Fi radio 706 of the AMP AP 702, and may be received using Wi-Fi radio 712 of the AMP wireless device 704.

At 722, the AMP AP 702 may transmit, and the AMP wireless device 704 may receive, a trigger frame that indicates the AMP wireless device 704 is to transmit one or more uplink PPDUs. At 724, the AMP wireless device 704 may transmit, and the AMP AP 702 may receive, an uplink PPDU. For example, a non-AMP PPDU, such as a Wi-Fi PPDU, may be transmitted to the AMP AP 702. At 726, the AMP AP 702 may transmit, and the AMP wireless device 704 may receive, an acknowledgement of the transmitted PPDU.

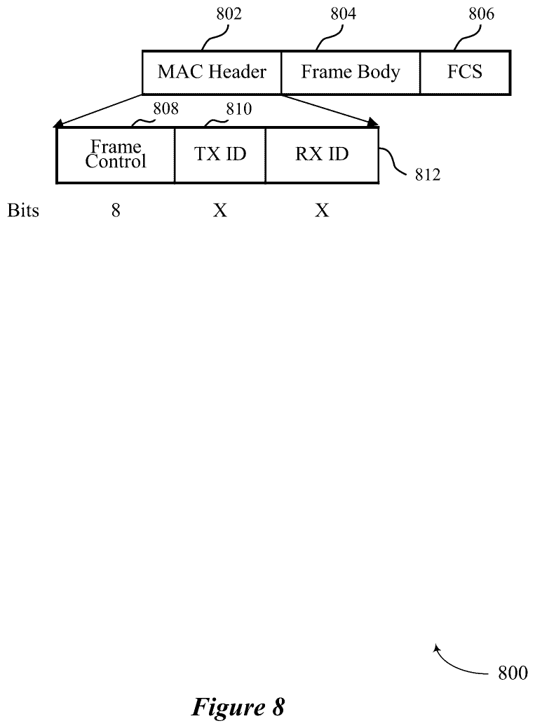

FIG. 8 shows an example of an AMP frame format 800 that supports wake-up signal protocols for ambient power enabled wireless devices. The AMP frame format 800 may implement aspects of, or be implemented by aspects of, the wireless communication network 100, the PPDU 250, the signaling diagrams 300, or the process flows 400, 500, 600, or 700. An AMP frame format 800 may provide for efficient and reliable communications between an AMP AP and am AMP wireless device.

In this example, the AMP frame format 800 includes a MAC header 802, a frame body 804, and a frame check sequence (FCS) 806. Further, the MAC header 802 may include a frame control field 808 (such as an 8-bit field), a transmitter ID field 810 (such as an X bit field, where X depends on a size of the ID), and a receiver ID field 812 (such as an X bit field, where X depends on a size of the ID). In some examples, an AMP wake-up frame in accordance with AMP frame format 800 may be sent to wake up one or more AMP wireless devices, such as AMP-enabled STAs. The transmitter ID field 810 may identify the transmitter of the AMP frame, and the receiver ID field 812 may identify the receiver of the AMP frame. In some aspects, for unicast transmissions, the receiver ID field 812 may identify the AMP wireless device to be awakened, and for multicast may identify a group of AMP wireless devices. Further, if a list of AIDs of AMP wireless devices is needed, the list may be included in the frame body 804. The same frame format can be used for an AMP acknowledgment frame sent by the AMP wireless device to indicate whether it will wake up or not, in which case the transmitter ID field 810 may identify the AMP wireless device that sends the acknowledgement, and the receiver ID field 812 may identify the transmitter that sent the AMP wake-up frame.

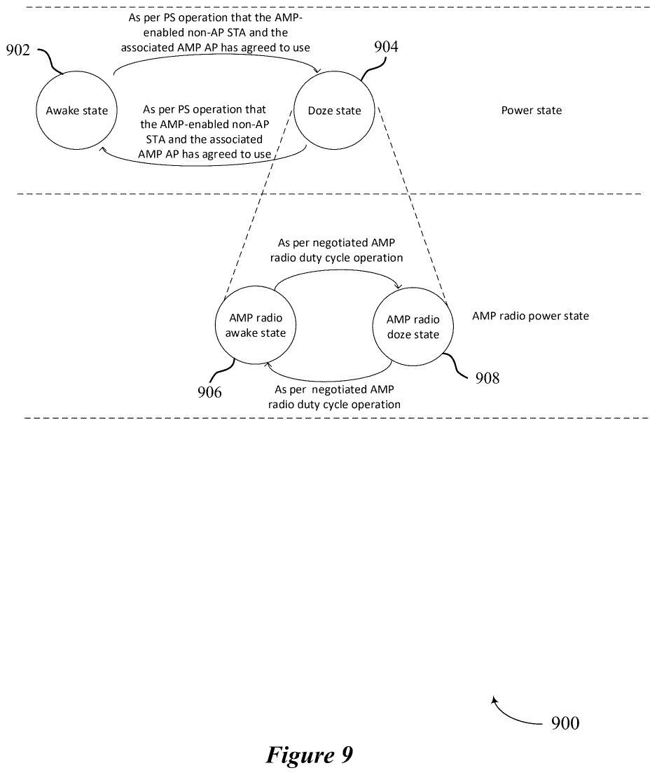

FIG. 9 shows an example of an AMP-enabled non-AP STA state diagram 900 that supports wake-up signal protocols for ambient power enabled wireless devices. The state diagram 900 may implement aspects of, or be implemented by aspects of, the wireless communication network 100, the PPDU 250, the signaling diagrams 300, the process flows 400, 500, 600, or 700, or the AMP frame format 800. The state diagram 900 may provide for efficient and reliable communications between an AMP AP and am AMP wireless device.

In this example, a higher-power state may include an awake state 902 and a doze state 904, and a lower-power state may provide that an AMP radio is active and other RF components are deactivated, where the AMP radio may have an awake state 906 and a doze state 908. Thus, in this example, a duty cycle operation for AMP may include AMP radio switching between the AMP radio awake state 906 and the AMP radio doze state 908, and a legacy power save operation based on the AMP-enabled non-AP STA and the associated AMP AP has agreed to use may include awake state 902 and doze state 904. In some aspects, the AMP-enabled non-AP STA may negotiate the duty cycle schedules with an AMP AP, which may transmit one or more WUSs in accordance with the AMP duty cycle, for exchange of PPDUs in accordance with the main radio duty cycle. In such cases, the AMP-enabled non-AP STA may further reduce power by moving the AMP radio to the AMP radio doze state 908, while being able to receive a WUS in accordance with the indicated duty cycle.

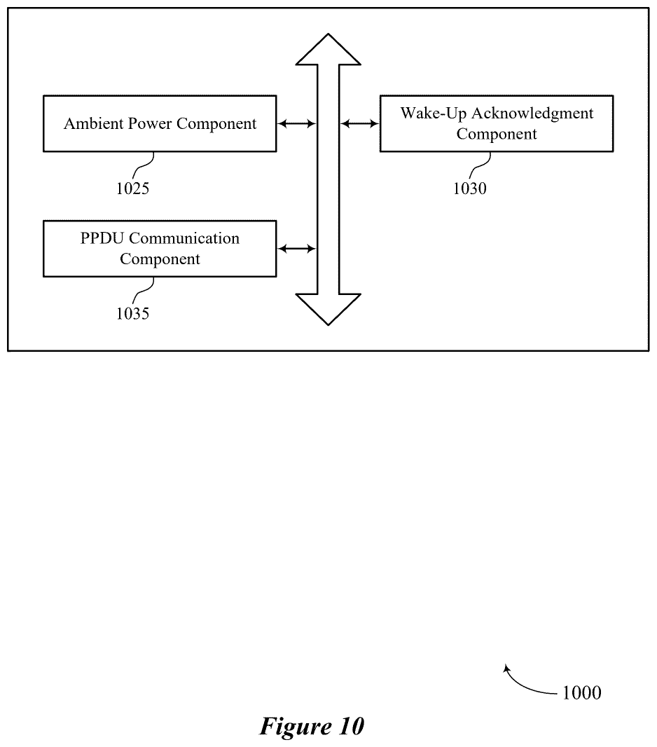

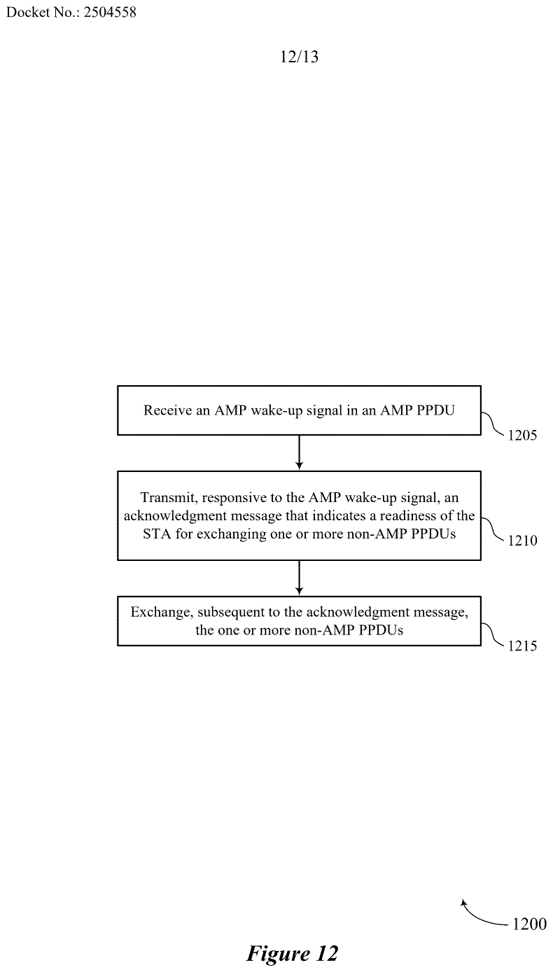

FIG. 10 shows a block diagram of an example wireless communication device 1000 that supports wake-up signal protocols for ambient power enabled wireless devices. In some examples, the wireless communication device 1000 is configured to perform the process 1200 described with reference to FIG. 12. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA, such as the STA 104 described with reference to FIG. 1. In some other examples, the wireless communication device 1000 can be a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes an ambient power component 1025, a wake-up acknowledgment component 1030, and a PPDU communication component 1035. Portions of one or more of the ambient power component 1025, the wake-up acknowledgment component 1030, and the PPDU communication component 1035 may be implemented at least in part in hardware or firmware. For example, one or more of the ambient power component 1025, the wake-up acknowledgment component 1030, and the PPDU communication component 1035 may be implemented at least in part by at least a processor or a modem. In some examples, portions of one or more of the ambient power component 1025, the wake-up acknowledgment component 1030, and the PPDU communication component 1035 may be implemented at least in part by a processor and software in the form of processor-executable code stored in memory.

The wireless communication device 1000 may support wireless communications in accordance with examples as disclosed herein. The ambient power component 1025 is configurable or configured to receive an AMP WUS in an AMP PPDU. The wake-up acknowledgment component 1030 is configurable or configured to transmit, responsive to the AMP wake-up signal, an acknowledgment message that indicates a readiness at the STA for exchanging one or more non-AMP PPDUs. The PPDU communication component 1035 is configurable or configured to exchange, subsequent to the acknowledgment message, the one or more non-AMP PPDUs.

In some examples, the acknowledgment message includes an AMP acknowledgment frame transmitted in an AMP PPDU. In some examples, the AMP wake-up signal is received at an ambient power radio of the STA, and the acknowledgment message is transmitted from a main radio of the STA. In some examples, the AMP wake-up signal indicates one or more identifiers, of one or more STAs. In some examples, the acknowledgment message is transmitted responsive to a determination at the STA that a sufficient amount of ambient power has been harvested to exchange non-AMP frames. In some examples, the one or more non-AMP PPDUs are received at the STA subsequent to a transition delay after transmitting the acknowledgement message. In some examples, the one or more PPDUs are exchanged in accordance with one or more temporal keys, one or more identifiers, or any combination thereof, that are stored in a memory at the STA.

In some examples, the ambient power component 1025 is configurable or configured to transmit an indication of one or more AMP capabilities of the STA to an AP, and the AMP wake-up signal and the acknowledgment message are in accordance with the one or more AMP capabilities of the STA. In some examples, the STA is a MLO STA that supports a plurality of links for communication of PPDUs, and wherein the acknowledgment message or the AMP wake-up signal indicates one or more links of the plurality of links that are to be activated at the STA. In some examples, the AMP wake-up signal indicates a first operation mode of a plurality of available operation modes of exchanging the non-AMP frames, and the exchange of non-AMP frames is activated in accordance with the first operation mode.

In some examples, the PPDU communication component 1035 is configurable or configured to transmit to an AP, an unsolicited uplink PPDU that is independent of the AMP wake-up signal, the unsolicited uplink PPDU transmitted based at least in part on a sufficient amount of ambient power being harvested at the STA for exchanging non-AMP frames. In some examples, the ambient power component 1025 is configurable or configured to transmit, to an AP, timing information that indicates a time duration between AMP wake-up signals. In some examples, the acknowledgment message includes a PS poll frame that is transmitted in an uplink non-AMP PPDU.

In some examples, the AMP wake-up signal is provided in an AMP wake-up frame that includes an identifier of an access point (AP) that transmitted the AMP wake-up signal, and an identifier of the STA, and wherein the identifier of the STA is provided in a unicast identifier that indicates only the identifier of the STA or a multicast identifier that indicates two or more STAs. In some examples, the acknowledgment message is provided in an AMP acknowledgment frame that includes the identifier of the STA and the identifier of the AP. In some examples, the STA operates in accordance with an AMP duty cycle that has an awake state and a sleep state, and wherein the AMP wake-up signal is received during the awake state of the AMP duty cycle.

In some examples, the ambient power component 1025 is configurable or configured to transmit, to an AP, an indication of the AMP duty cycle, where the AMP wake-up signal and the acknowledgment message are transmitted in accordance with the AMP duty cycle.

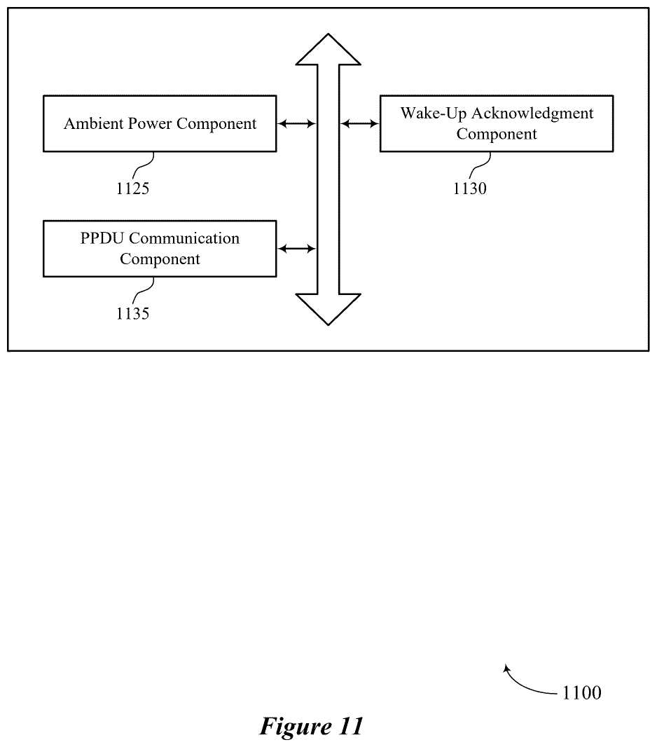

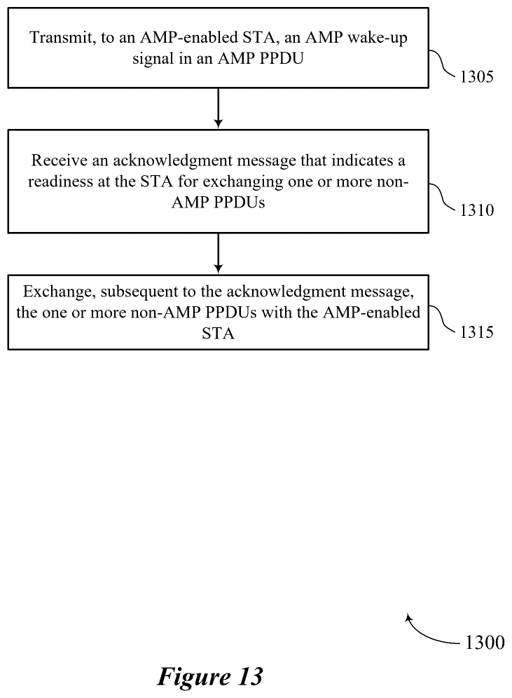

FIG. 11 shows a block diagram of an example wireless communication device 1100 that supports wake-up signal protocols for ambient power enabled wireless devices. In some examples, the wireless communication device 1100 is configured to perform the process 1300 described with reference to FIG. 13. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes an ambient power component 1125, a wake-up acknowledgment component 1130, and a PPDU communication component 1135. Portions of one or more of the ambient power component 1125, the wake-up acknowledgment component 1130, and the PPDU communication component 1135 may be implemented at least in part in hardware or firmware. For example, one or more of the ambient power component 1125, the wake-up acknowledgment component 1130, and the PPDU communication component 1135 may be implemented at least in part by at least a processor or a modem. In some examples, portions of one or more of the ambient power component 1125, the wake-up acknowledgment component 1130, and the PPDU communication component 1135 may be implemented at least in part by a processor and software in the form of processor-executable code stored in memory.

The wireless communication device 1100 may support wireless communications in accordance with examples as disclosed herein. The ambient power component 1125 is configurable or configured to transmit, to an AMP-enabled STA, an AMP wake-up signal in an AMP physical layer PPDU. The wake-up acknowledgment component 1130 is configurable or configured to receive an acknowledgment message that indicates a readiness at the STA for exchanging one or more non-AMP PPDUs. The PPDU communication component 1135 is configurable or configured to exchange, subsequent to the acknowledgment message, the one or more non-AMP PPDUs with the AMP-enabled STA.

In some examples, the acknowledgment message includes an AMP acknowledgment frame transmitted in an AMP PPDU. In some examples, the AMP wake-up signal indicates one or more identifiers, of the STAs. In some examples, the one or more non-AMP PPDUs are transmitted to the STA subsequent to a transition delay after receiving the acknowledgement message. In some examples, the one or more PPDUs are exchanged in accordance with one or more temporal keys, one or more identifiers, or any combination thereof, that are stored at the AMP-enabled STA.

In some examples, the ambient power component 1125 is configurable or configured to receive an indication of one or more AMP capabilities of the AMP-enabled STA, and the AMP wake-up signal and the acknowledgment message are in accordance with the one or more AMP capabilities of the AMP-enabled STA. In some examples, the AMP-enabled STA is a MLO STA that supports a plurality of links for communication of PPDUs, and the acknowledgment message or the AMP wake-up signal indicates one or more links of the plurality of links that are to be activated at the STA. In some examples, the AMP wake-up signal indicates a first operation mode of a plurality of available operation modes of exchanging the non-AMP frames, and the exchange of non-AMP frames is activated in accordance with the first operation mode.

In some examples, the PPDU communication component 1135 is configurable or configured to receive, from the AMP-enabled STA, an unsolicited uplink PPDU that is independent of the AMP wake-up signal, wherein the AMP-enabled STA is configured to transmit the unsolicited uplink PPDU based at least in part on a sufficient amount of ambient power being harvested at the AMP-enabled STA for exchanging non-AMP frames. In some examples, the PPDU communication component 1135 is configurable or configured to receive, from the AMP-enabled STA, timing information that indicates a time duration between AMP wake-up signals.

In some examples, the acknowledgment message includes a PS poll frame. In some examples, the AMP wake-up signal is provided in an AMP wake-up frame that includes an identifier of the AP, and an identifier of the AMP-enabled STA, and the identifier of the AMP-enabled STA is provided in a unicast identifier that indicates only the identifier of the AMP-enabled STA or a multicast identifier that indicates two or more STAs. In some examples, the acknowledgment message is provided in an AMP acknowledgment frame that includes the identifier of the AMP-enabled STA and the identifier of the AP.

In some examples, the ambient power component 1125 is configurable or configured to receive, from the AMP-enabled STA, scheduling information that indicates the AMP-enabled STA operates in accordance with an AMP duty cycle that has an awake state and a sleep state, and where the AMP wake-up signal is transmitted during the awake state of the AMP duty cycle. In some examples, the ambient power component 1125 is configurable or configured to receive, from the AMP-enabled STA, an indication of the AMP duty cycle, and wherein the AMP wake-up signal and the acknowledgment message are transmitted in accordance with the AMP duty cycle.

FIG. 12 shows a flowchart illustrating an example process 1200 performable by or at a STA that supports wake-up signal protocols for ambient power enabled wireless devices. The operations of the process 1200 may be implemented by a STA or its components as described herein. For example, the process 1200 may be performed by a wireless communication device, such as the wireless communication device 1000 described with reference to FIG. 10, operating as or within a wireless STA. In some examples, the process 1200 may be performed by a wireless STA, such as one of the STAs 104 described with reference to FIG. 1.

In some examples, in 1205, the STA may receive an AMP wake-up signal in an AMP PPDU. In some implementations, aspects of the operations of 1205 may be performed by an ambient power component 1025 as described with reference to FIG. 10.

In some examples, in 1210, the STA may transmit, responsive to the AMP wake-up signal, an acknowledgment message that indicates a readiness of the STA for exchanging one or more non-AMP PPDUs. In some implementations, aspects of the operations of 1210 may be performed by a wake-up acknowledgment component 1030 as described with reference to FIG. 10.

In some examples, in 1215, the STA may exchange, subsequent to the acknowledgment message, the one or more non-AMP PPDUs. In some implementations, aspects of the operations of 1215 may be performed by a PPDU communication component 1035 as described with reference to FIG. 10.

FIG. 13 shows a flowchart illustrating an example process 1300 performable by or at an AP that supports wake-up signal protocols for ambient power enabled wireless devices. The operations of the process 1300 may be implemented by an AP or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the AP may transmit, to an AMP-enabled STA, an AMP wake-up signal in an AMP PPDU. In some implementations, aspects of the operations of 1305 may be performed by an ambient power component 1125 as described with reference to FIG. 11.

In some examples, in 1310, the AP may receive an acknowledgment message that indicates a readiness at the STA for exchanging one or more non-AMP PPDUs. In some implementations, aspects of the operations of 1310 may be performed by a wake-up acknowledgment component 1130 as described with reference to FIG. 11.

In some examples, in 1315, the AP may exchange, subsequent to the acknowledgment message, the one or more non-AMP PPDUs with the AMP-enabled STA. In some implementations, aspects of the operations of 1315 may be performed by a PPDU communication component 1135 as described with reference to FIG. 11.

The following provides an overview of clauses of the present disclosure:

Clause 1: A method for wireless communications at a STA, comprising: receiving, an AMP wake-up signal at the STA in an AMP PPDU; transmitting, responsive to the AMP wake-up signal, an acknowledgment message that indicates a readiness at the STA for exchanging one or more non-AMP PPDUs; and exchanging, subsequent to the acknowledgment message, the one or more non-AMP PPDUs.

Clause 2: The method of clause 1, wherein the acknowledgment message includes an AMP acknowledgment frame transmitted in an AMP PPDU.

Clause 3: The method of any of clauses 1 through 2, wherein the AMP wake-up signal is received at an ambient power radio of the STA, and the acknowledgment message is transmitted from a main radio of the STA.

Clause 4: The method of any of clauses 1 through 3, wherein the AMP wake-up signal indicates one or more identifiers, of one or more STAs.

Clause 5: The method of any of clauses 1 through 4, wherein the acknowledgment message is transmitted responsive to a determination at the STA that a sufficient amount of ambient power has been harvested to exchange non-AMP frames.

Clause 6: The method of any of clauses 1 through 5, wherein the one or more non-AMP PPDUs are received at the STA subsequent to a transition delay after transmitting the acknowledgement message.

Clause 7: The method of any of clauses 1 through 6, wherein the one or more PPDUs are exchanged in accordance with one or more temporal keys, one or more identifiers, or any combination thereof, that are stored in a memory at the STA.

Clause 8: The method of any of clauses 1 through 7, further comprising: transmitting an indication of one or more AMP capabilities of the STA to an AP, and wherein the AMP wake-up signal and the acknowledgment message are in accordance with the one or more AMP capabilities of the STA.

Clause 9: The method of any of clauses 1 through 8, wherein the STA is a MLO STA that supports a plurality of links for communication of PPDUs, and the acknowledgment message or the AMP wake-up signal indicates one or more links of the plurality of links that are to be activated at the STA.

Clause 10: The method of any of clauses 1 through 9, wherein the AMP wake-up signal indicates a first operation mode of a plurality of available operation modes of exchanging non-AMP frames, and the exchange of non-AMP frames is activated in accordance with the first operation mode.

Clause 11: The method of any of clauses 1 through 10, further comprising: transmitting to an AP, an unsolicited uplink PPDU that is independent of the AMP wake-up signal, the unsolicited uplink PPDU transmitted based at least in part on a sufficient amount of ambient power being harvested at the STA for exchanging non-AMP frames.

Clause 12: The method of any of clauses 1 through 11, further comprising: transmitting, to an AP, timing information that indicates a time duration between AMP wake-up signals.

Clause 13: The method of any of clauses 1 through 12, wherein the acknowledgment message includes a PS poll frame that is transmitted in an uplink non-AMP PPDU.

Clause 14: The method of any of clauses 1 through 13, wherein the AMP wake-up signal is provided in an AMP wake-up frame that includes an identifier of an AP that transmitted the AMP wake-up signal, and an identifier of the STA, and the identifier of the STA is provided in a unicast identifier that indicates only the identifier of the STA or a multicast identifier that indicates two or more STAs.

Clause 15: The method of clause 14, wherein the acknowledgment message is provided in an AMP acknowledgment frame that includes the identifier of the STA and the identifier of the AP.

Clause 16: The method of any of clauses 1 through 15, wherein the STA operates in accordance with an AMP duty cycle that has an awake state and a sleep state, and the AMP wake-up signal is received during the awake state of the AMP duty cycle.

Clause 17: The method of clause 16, further comprising: transmitting, to an AP, an indication of the AMP duty cycle, and wherein the AMP wake-up signal and the acknowledgment message are transmitted in accordance with the AMP duty cycle.

Clause 18: A method for wireless communications at an AP, comprising: transmitting, to an AMP-enabled STA, an AMP wake-up signal in an AMP PPDU; receiving an acknowledgment message that indicates a readiness at the STA for exchanging one or more non-AMP PPDUs; and exchanging, subsequent to the acknowledgment message, the one or more non-AMP PPDUs with the AMP-enabled STA.

Clause 19: The method of clause 18, wherein the acknowledgment message includes an AMP acknowledgment frame transmitted in an AMP PPDU.

Clause 20: The method of any of clauses 18 through 19, wherein the AMP wake-up signal indicates one or more identifiers, of one or more STAs.

Clause 21: The method of any of clauses 18 through 20, wherein the one or more non-AMP PPDUs are transmitted to the STA subsequent to a transition delay after receiving the acknowledgement message.

Clause 22: The method of any of clauses 18 through 21, wherein the one or more PPDUs are exchanged in accordance with one or more temporal keys, one or more identifiers, or any combination thereof, that are stored at the AMP-enabled STA.

Clause 23: The method of any of clauses 18 through 22, further comprising: receiving an indication of one or more AMP capabilities of the AMP-enabled STA, and wherein the AMP wake-up signal and the acknowledgment message are in accordance with the one or more AMP capabilities of the AMP-enabled STA.

Clause 24: The method of any of clauses 18 through 23, wherein the AMP-enabled STA is a MLO STA that supports a plurality of links for communication of PPDUs, and the acknowledgment message or the AMP wake-up signal indicates one or more links of the plurality of links that are to be activated at the STA.

Clause 25: The method of any of clauses 18 through 24, wherein the AMP wake-up signal indicates a first operation mode of a plurality of available operation modes of exchanging non-AMP frames, and the exchange of non-AMP frames is activated in accordance with the first operation mode.

Clause 26: The method of any of clauses 18 through 25, further comprising: receiving, from the AMP-enabled STA, an unsolicited uplink PPDU that is independent of the AMP wake-up signal, wherein the AMP-enabled STA is configured to transmit the unsolicited uplink PPDU based at least in part on a sufficient amount of ambient power being harvested at the AMP-enabled STA for exchanging non-AMP frames.

Clause 27: The method of any of clauses 18 through 26, further comprising: receiving, from the AMP-enabled STA, timing information that indicates a time duration between AMP wake-up signals.

Clause 28: The method of any of clauses 18 through 27, wherein the acknowledgment message includes a power-save (PS) poll frame.

Clause 29: The method of any of clauses 18 through 28, wherein the AMP wake-up signal is provided in an AMP wake-up frame that includes an identifier of the AP, and an identifier of the AMP-enabled STA, and the identifier of the AMP-enabled STA is provided in a unicast identifier that indicates only the identifier of the AMP-enabled STA or a multicast identifier that indicates two or more STAs.

Clause 30: The method of clause 29, wherein the acknowledgment message is provided in an AMP acknowledgment frame that includes the identifier of the AMP-enabled STA and the identifier of the AP.

Clause 31: The method of any of clauses 18 through 30, further comprising: receiving, from the AMP-enabled STA, scheduling information that indicates the AMP-enabled STA operates in accordance with an AMP duty cycle that has an awake state and a sleep state, and wherein the AMP wake-up signal is transmitted during the awake state of the AMP duty cycle.

Clause 32: The method of clause 31, further comprising: receiving, from the AMP-enabled STA, an indication of the AMP duty cycle, and wherein the AMP wake-up signal and the acknowledgment message are transmitted in accordance with the AMP duty cycle.

Clause 33: A STA for wireless communications, comprising a processing system that includes processor circuitry and memory circuitry that stores code, the processing system configured to cause the STA to perform a method of any of clauses 1 through 17.

Clause 34: A STA for wireless communications, comprising at least one means for performing a method of any of clauses 1 through 17.

Clause 35: A non-transitory computer-readable medium storing code for wireless communications, the code comprising instructions executable by one or more processors to perform a method of any of clauses 1 through 17.

Clause 36: An AP for wireless communications, comprising a processing system that includes processor circuitry and memory circuitry that stores code, the processing system configured to cause the AP to perform a method of any of clauses 18 through 32.

Clause 37: An AP for wireless communications, comprising at least one means for performing a method of any of clauses 18 through 32.

Clause 38: A non-transitory computer-readable medium storing code for wireless communications, the code comprising instructions executable by one or more processors to perform a method of any of clauses 18 through 32.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A station (STA), comprising:
a processing system that includes processor circuitry and memory circuitry that stores code, the processing system configured to cause the STA to:
receive an ambient power (AMP) wake-up signal at the STA in an AMP physical layer protocol data unit (PPDU);
transmit, responsive to the AMP wake-up signal, an acknowledgment message that indicates a readiness of the STA for exchanging one or more non-AMP PPDUs; and
exchange, subsequent to the acknowledgment message, the one or more non-AMP PPDUs.

2. The STA of claim 1, wherein the acknowledgment message includes an AMP acknowledgment frame transmitted in an AMP PPDU.

3. The STA of claim 1, wherein the acknowledgment message is transmitted based at least in part on a determination at the STA that a sufficient amount of ambient power has been harvested to exchange non-AMP frames.

4. The STA of claim 1, wherein the one or more non-AMP PPDUs are received at the STA subsequent to a transition delay after transmitting the acknowledgment message.

5. The STA of claim 1, wherein the processing system is further configured to cause the STA to:
transmit an indication of one or more AMP capabilities of the STA to an access point (AP), and wherein the AMP wake-up signal and the acknowledgment message are in accordance with the one or more AMP capabilities of the STA.

6. The STA of claim 1, wherein the STA is a multi-link operation (MLO) STA that supports a plurality of links for communication of PPDUs, and wherein the acknowledgment message or the AMP wake-up signal indicates one or more links of the plurality of links that are to be activated at the STA.

7. The STA of claim 1, wherein the AMP wake-up signal indicates a first operation mode of a plurality of available operation modes of exchanging non-AMP frames, and the exchange of non-AMP frames is activated in accordance with the first operation mode.

8. The STA of claim 1, wherein the acknowledgment message includes a power-save (PS) poll frame that is transmitted in an uplink PPDU.

9. The STA of claim 1, wherein the AMP wake-up signal is provided in an AMP wake-up frame that includes an identifier of an access point (AP) that transmitted the AMP wake-up signal, and an identifier of the STA, and wherein the identifier of the STA is provided in a unicast identifier that indicates only the identifier of the STA or a multicast identifier that indicates two or more STAs.

10. The STA of claim 1, wherein the STA operates in accordance with an AMP duty cycle that has an awake state and a sleep state, and wherein the AMP wake-up signal is received during the awake state of the AMP duty cycle.

11. A method for wireless communications at a station (STA), comprising:
receiving, an ambient power (AMP) wake-up signal at the STA in an AMP physical layer protocol data unit (PPDU);
transmitting, responsive to the AMP wake-up signal, an acknowledgment message that indicates a readiness at the STA for exchanging one or more non-AMP PPDUs; and
exchanging, subsequent to the acknowledgment message, the one or more non-AMP PPDUs.

12. The method of claim 11, wherein the acknowledgment message includes an AMP acknowledgment frame transmitted in an AMP PPDU.

13. The method of claim 11, wherein the AMP wake-up signal is received at an ambient power radio of the STA, and the acknowledgment message is transmitted from a main radio of the STA.

14. The method of claim 11, wherein the STA is a multi-link operation (MLO) STA that supports a plurality of links for communication of PPDUs, and wherein the acknowledgment message or the AMP wake-up signal indicates one or more links of the plurality of links that are to be activated at the STA.

15. The method of claim 11, further comprising:
transmitting, to an access point (AP), timing information that indicates a time duration between AMP wake-up signals.

16. The method of claim 11, wherein the acknowledgment message includes a power-save (PS) poll frame that is transmitted in an uplink non-AMP PPDU.

17. The method of claim 11, wherein the AMP wake-up signal is provided in an AMP wake-up frame that includes an identifier of an access point (AP) that transmitted the AMP wake-up signal, and an identifier of the STA, and wherein the identifier of the STA is provided in a unicast identifier that indicates only the identifier of the STA or a multicast identifier that indicates two or more STAs.

18. A non-transitory computer-readable medium storing code for wireless communications, the code comprising instructions executable by one or more processors to:
receive an ambient power (AMP) wake-up signal at a station (STA) in an AMP physical layer protocol data unit (PPDU);
transmit, responsive to the AMP wake-up signal, an acknowledgment message that indicates a readiness of the STA for exchanging one or more non-AMP PPDUs; and
exchange, subsequent to the acknowledgment message, the one or more non-AMP PPDUs.

19. The non-transitory computer-readable medium of claim 18, wherein the acknowledgment message includes an AMP acknowledgment frame transmitted in an AMP PPDU.

20. The non-transitory computer-readable medium of claim 18, wherein the acknowledgment message includes a power-save (PS) poll frame that is transmitted in an UL PPDU.
